(19) United States
(12) Patent Application Publication
(10) Pub. No.: US 2026/0061615 A1
(43) Pub. Date: Mar. 5, 2026

(54) SYSTEMS AND METHODS FOR AUTOMATIC MODULE DC WIRING

(71) Applicant: Terabase Energy, Inc., Berkeley, CA (US)

(72) Inventors: Soren Jensen, Corte Madera, CA (US); Adam Hansel, Davis, CA (US); Matthew Paul Campbell, Berkeley, CA (US)

(73) Assignee: Terabase Energy, Inc., Berkeley, CA (US)

(21) Appl. No.: 18/824,894

(22) Filed: Sep. 4, 2024

(51) Int. Cl. B25J 9/16; B25J 11/00; H02S 40/36

(52) U.S. Cl. CPC B25J 9/1679; B25J 9/1694; B25J 11/008; H02S 40/36

(57) ABSTRACT

In a typical large-scale solar system, thousands of solar modules are wired together, with thousands of connector connections performed manually by on-site installers. Such a process is time-consuming and subject to improper or loose connections for some modules. Described hereinafter are system and method embodiments of automatic module DC wiring to improve the installation quality, efficiency, and consistency for large-scale solar systems. A controller receives ambient images captured by a camera to identify and locate module connectors and operates a robotic arm to perform connector connection based on the identified and located connectors and also wiring schemes received from a server regarding the modules in the solar system. The robotic arm may also be controlled for connection verification to ensure the solar module is correctly wired. Implementation of the presented invention may greatly increase efficiency, consistency, and connection quality for module DC wiring.

### TECHNICAL FIELD

The present disclosure relates generally to solar module installation. More particularly, the present disclosure relates to systems and methods for automatic module DC wiring for improved solar module installation efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the cost-effective management of the construction process and the ability to improve on-site installation efficiency during the construction process.

FIG. 1 shows a typical solar farm 105 comprising an array of installed solar tables 110. Each table comprises multiple solar modules 115. A large-scale solar farm typically includes thousands of solar modules that are located across a multi-acre terrain and that are electrically coupled to provide a source of energy. These large-scale systems are often located in remote areas and require a significant investment in materials, resources, and labor for on-site installation. It can be very challenging to maintain consistent installation processes at each point of installation within a construction site across large areas. These issues further contribute to an increase in the cost and complexity of a very cost-sensitive process.

FIG. 2 shows an installation of solar modules on a construction site. Multiple solar modules 205/206/ . . . /are securely aligned and attached to a shaft or torque tube 210 to form a row of solar modules, which are supported by ground piles 220. To securely attach a solar module to a torque tube, one or more module frames 215 of the solar module are firmly connected to a mounting bracket or rail 225, which is firmly clamped or coupled to the torque tube 210. The multiple solar modules 205/206/ . . . /are connected electrically via photovoltaic (PV) cables 230 in series, parallel, or a combination of both to create an electrical circuit to deliver DC power in a desired DC output voltage and current, which is converted by an inverter into AC power.

In a large-scale solar system, there are thousands of solar modules that are typically wired on-site, which is a very time-consuming process and drives up the overall installation process and cost. Furthermore, such a manual DC wiring process may negatively impact installation quality and consistency, especially for large solar systems.

What is needed are systems, devices, and methods that facilitate the automation of module DC wiring to improve the installation quality, efficiency, and consistency for large-scale solar systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 depicts a typical large-scale solar farm comprising an array of installed solar tables, with each solar table comprising multiple solar modules.

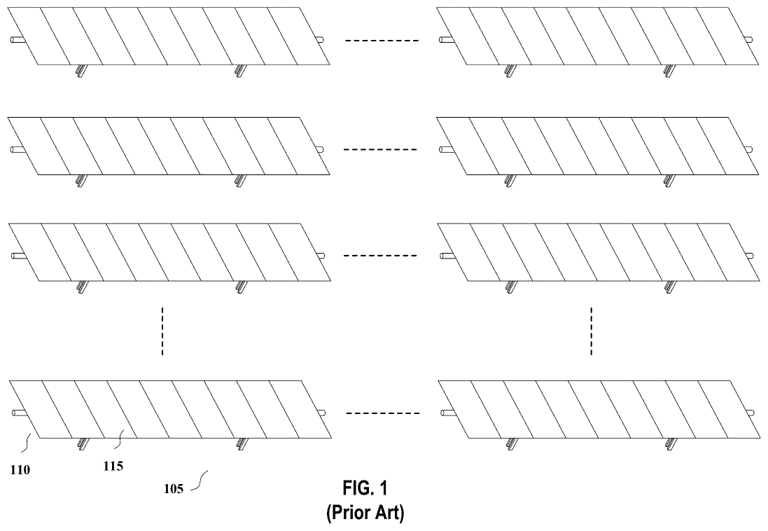

FIG. 2 shows an installation of solar tables on a construction site.

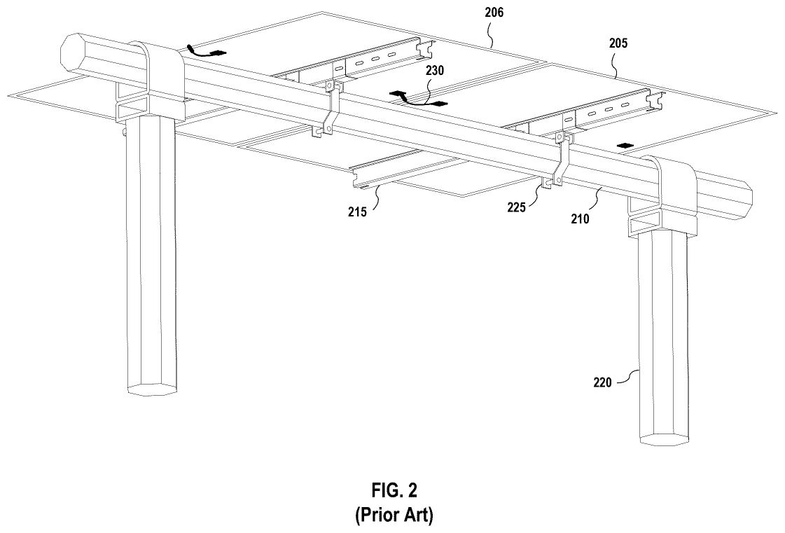

FIG. 3 shows a back view of two solar modules for electrical connection.

FIG. 4 shows typical PV connectors for solar module wiring.

FIG. 5 shows an overview of a system for automatic module DC wiring in accordance with various embodiments of the invention.

FIG. 6 shows a process for automatic module DC wiring in accordance with various embodiments of the invention.

FIG. 7 shows completed module DC wiring between two adjacent modules in accordance with various embodiments of the invention.

FIG. 8 shows an overview of a system with two robotic arms for automatic module DC wiring in accordance with various embodiments of the invention.

FIG. 9 shows an overview of a system with one or more robotic arms for automatic module DC wiring at a centralized solar table assembly line in accordance with various embodiments of the invention.

FIG. 10 shows a simplified block diagram of a computing system in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of a self-closing rail.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

Furthermore, it shall be noted that many embodiments described herein are given in the context of the assembly and installation of large numbers of solar modules within a system, but one skilled in the art shall recognize that the teachings of the present disclosure may apply to other large and complex construction sites to implement automatic wiring connection for improving installation quality, efficiency, and consistency.

In this document, “large-scale solar system” refers to a solar system having 1000 or more solar modules. The term “solar table” refers to a structural assembly comprising one or more photovoltaic (PV) or solar modules and/or one or more module frames (or purlins) for module support. Some types of solar modules may have electrical harnesses and supplemental structures that allow them to connect to other solar modules or foundations/piles while other types do not have this supplemental structure.

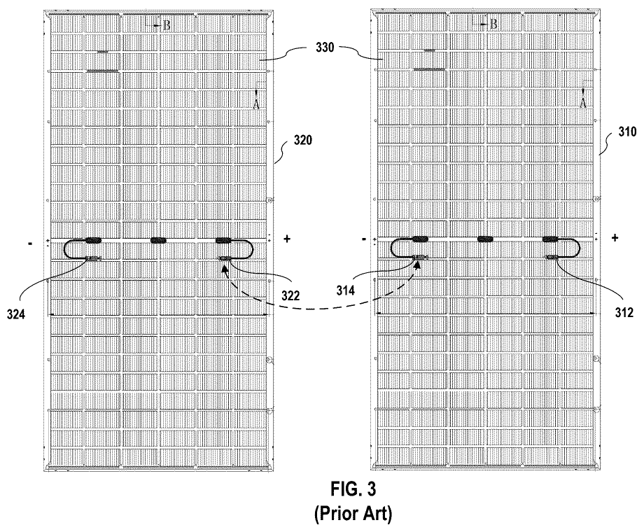

FIG. 3 shows a back side view of two solar modules 310 and 320 for electrical connection in accordance with various embodiments of the invention. Each solar module comprises multiple interconnected small solar cells 330 arranged in a larger unit. These small cells work collectively to generate higher power outputs than individual cells alone. The first solar module 310 has a first positive connector 312 on one side and a first negative connector 314 on the opposite side. The second solar module 320 has a second positive connector 324 on one side and a second negative connector 322 on the opposite side.

Solar modules may be wired in series, parallel, or a combination of series and parallel connections (also referred to as series-parallel connections). A series connection is wiring the positive terminal of a module to the negative of another module, as shown in FIG. 3 with the second positive connector 322 connected to the first negative connector 314. Multiple modules connected in serial may be referred to as a module string to increase the output voltage of the solar modules to a desired DC voltage up to 1,500V maximum voltage. In a large solar farm, solar modules within a solar table are normally connected in series, and a module string may cross one or more solar tables.

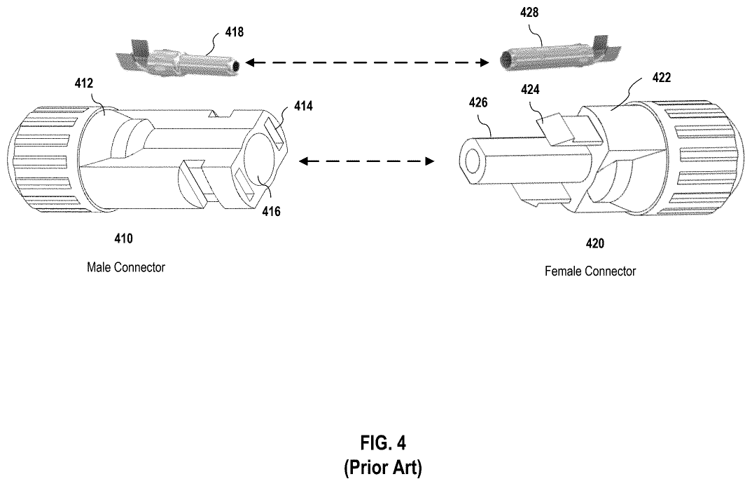

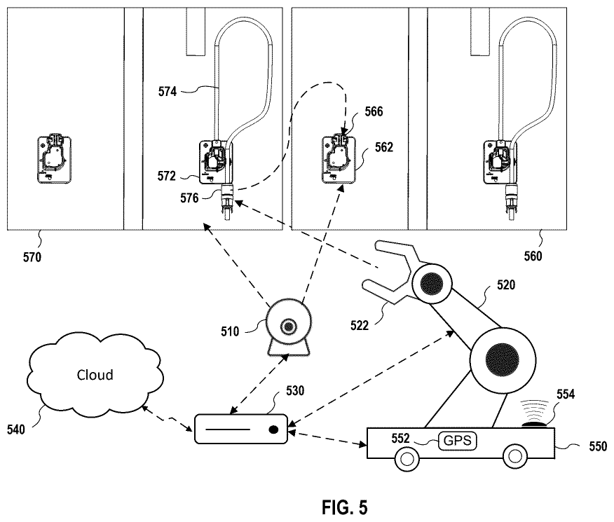

FIG. 4 shows typical PV connectors for solar module wiring. Solar modules may come with positive (+) and negative (−) wires. One end of each wire is connected to an electrical terminal or a junction box of the panel. In most solar panels, the other end of each wire is terminated with a single-contact electrical connector, e.g., an MC4 connector. The MC4 stands for Multi-Contact Connectors with a 4 mm diameter contact pin. The positive (+) wire typically has a female MC4 connector 420, and the negative (−) wire typically has a male MC4 connector 410. Alternatively, solar modules may come with a connector combined with a junction box and a single wire, as shown in FIG. 5. To wire solar module having two wires, a connector of a wire of one solar module needs to be connected to a corresponding connector of a wire of another solar module. To wire solar modules that only have only a single wire, a connector of the single wire of one solar module needs to be connected to a corresponding junction box of another solar module.

The female MC4 connector 420 comprises a female insulation housing 422 and a metallic female contact 428 placed within a plug 426 of the female connector housing 422. The female connector housing 422 incorporates a pair of locking tabs 424. The male MC4 connector 410 comprises a male insulation housing 412 and a metallic male contact 418 placed within a socket 416 of the male connector housing 412. The male connector housing 412 incorporates a pair of locking slots 414 for receiving and locking the pair of locking tabs 424. When the male MC4 connector 410 is connected to the female MC4 connector 420 correctly, the metallic male contact 418 is inserted within the metallic female contact 428 for electrical connection; the plug 426 of the female insulation housing 422 is inserted into the socket 416 of the male connector housing 412; and the pair of locking slots 414 receives and locks the pair of locking tabs 424, thereby effectively preventing unintentional or accidental disconnection. It shall be noted that, in the present application, the male and female designation is based on the coupling characteristic of the metallic contacts 418/428 instead of the plug and the socket of the connector housing 412/422.

In a typical large-scale solar system, thousands of solar modules are wired together, with thousands of connector connections performed manually by on-site installers. Such a process is time-consuming and subject to improper or loose connections for some modules. Described hereinafter are system and method embodiments of automatic module DC wiring to improve the installation quality, efficiency, and consistency for large-scale solar systems.

### A. Embodiments of On-Site Automatic Module DC Wiring

FIG. 5 shows an overview of a system for on-site automatic module DC wiring in accordance with various embodiments of the invention. The system comprises a camera 510 (or a light detection and ranging (Lidar) imaging system), a robotic arm 520, and a controller 530. These components may be discrete components or integrated together, e.g., as an autonomous robot, to perform automatic module DC wiring.

The camera 510 captures ambient images around installed solar modules, e.g., modules 560 and 570, and transmits captured images in real time to a controller 530, which controls the movement of a robotic arm 520 based on at least the captured images to implement module DC wiring. In one or more embodiments, the camera 510 may be a stereo camera comprising two or more lens with a separate image sensor for each lens to capture three-dimensional (3-D) images for 3D information. The camera 510 may also be able to change direction, image resolution, and/or zoom levels under the control of the controller 530 to update a view angle or one or more imaging parameters for ambient images.

The robotic arm 520 is a multi-axis robot capable of moving with multiple degrees of freedom to allow the robotic arm to move to a programmed point. The robotic arm 520 comprises a gripper 522 that can perform gripping, releasing, extending, withdrawing, and/or rotation operations. The gripping force, extending/withdrawing force, and rotation speed/torque may be programmable for desired values, respectively. The robotic arm 520 may be deployed on a vehicle 550 so that the robotic arm 520 can be transported to various locations for automatic wiring operations. The vehicle 550 may incorporate a GPS sensor 552 for vehicle location tracking and reporting to the controller 530 for coordinating movement of the robotic arm.

In one or more embodiments, the camera 510 may be integrated into the robotic arm 520. For example, the lens of the camera 510 may be placed within the gripper 522 for an unobstructed view, regardless of the motion of the robotic arm 520. Furthermore, the controller 530 and the robotic arm 520 may be integrated into the vehicle 550 such that the vehicle 550 may function as an autonomous vehicle for automatic module DC wiring. The vehicle 550 may incorporate a wireless communication interface 554 to receive instructions and transmit wiring operation updates. For example, the controller 530 may be placed within the vehicle 550 and coupled to the wireless communication interface 554 to communicate with a server 540, which may be a cloud server 540. The controller 530 may receive from the server 540 a task of module DC wiring for multiple solar modules across a designated area of a solar farm under construction. The task may further comprise module wiring arrangements (series, parallel, or a combination of both) and connectors of the multiple solar modules. The controller 530 may also send module DC wiring update to the server 540. For example, when the robotic arm 520 completes the connection of the MC4 female connector 576 of the cable 574, which is connected to a positive terminal 572 on a solar module 570, to the MC4 male connector 566 that is directly placed on a negative terminal 562 on a solar module 560, the controller 530 sends an update indicating completeness of DC wiring between the solar module 560 and the solar module 570 to the cloud server 540.

The controller 530 may comprise one or more processors and a memory that is loaded with algorithms for automatic module DC wiring. The algorithms may comprise instructions for image processing, connector feature recognition, robotic arm movement control, vehicle motion control, etc. The algorithms may comprise machine learning (ML) or artificial intelligence (AI) codes that were pre-trained for optimized performance.

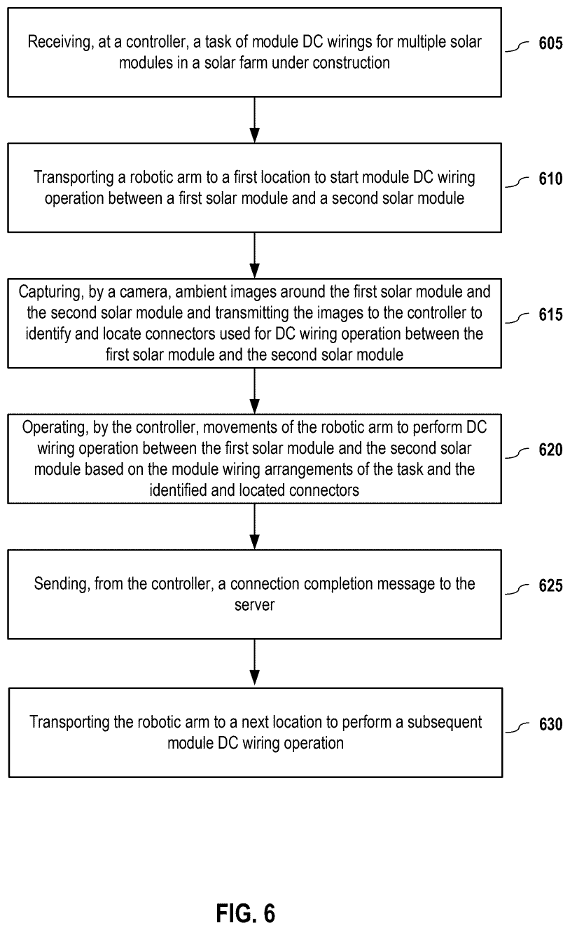

FIG. 6 shows a process for automatic module DC wiring in accordance with various embodiments of the invention. In step 605, the controller receives a task of module DC wirings for multiple solar modules in a solar farm under construction. The task comprises module wiring arrangements and connector information of the multiple solar modules.

In step 610, the robotic arm is transported initially to a first location to start module DC wiring operation between a first solar module and a second solar module.

In step 615, ambient images around the first solar module and the second solar module are captured by a camera and transmitted to the controller to identify and locate connectors used for DC wiring operation between the first solar module and the second solar module. The connectors may be identified based on the connector information of the multiple solar modules in the task via recognition of one or more connector features, e.g., connector type, locking slots, locking tabs, a plug on a male connector, a socket on a male connector, etc.

In step 620, the controller operates movements of the robotic arm to perform DC wiring operation between the first solar module and the second solar module based on the module wiring arrangements of the task and the identified and located connectors. In one or more embodiments, robotic arm movements comprise one or more gripper movements including gripping, pushing, and releasing. For example, the robotic arm may be operated to approach and grip the MC4 female connector 576, move the connector 576 in proximate to the corresponding MC4 male connector 566, align a pose of the gripped MC4 female connector 576 for connection, engage a connection between the MC4 female connector 576 and the MC4 male connector 566, release the gripper, etc.

In one or more embodiments, a cleaning operation may be performed right before any module DC wiring operations. Since modules might have been stored on-site for weeks or months before being installed or wired, dust may accumulate in the connectors and impact the reliability and quality of module DC wiring. A cleaning operation may be performed using an air nozzle powered by an air compressor or an air tank to blow away the accumulated dust on connectors and junction boxes of solar modules. The air compressor or air tank may be placed next to the robotic arm(s) and controlled by the controller for operation collaboration.

In one or more embodiments, the engagement of the connection may comprise applying a predetermined insertion force and a predetermined movement distance under the predetermined insertion force. In one or more embodiments, step 620 may further comprise a procedure of connection verification. As shown in FIG. 4, once the male connector 410 is properly connected to the female connector 420, the locking tabs 424 are locked in the pair of locking slots 414. A predetermined force (e.g., a few Newtons) may be applied by the robotic arm for a predetermined interval (e.g., ˜1 second) in an attempt for disconnection. If the MC4 female connector 576 and the MC4 male connector 566 are correctly connected, such a predetermined force would not be adequate to disconnect the connectors. If no displacement of the robotic arm is detected, the connection is viewed as a successful connection, and the robotic arm is then operated to release the gripper. Otherwise, if a displacement of the robotic arm is detected, the connection is viewed as a failed connection, and the robotic arm may be operated for a subsequent connection attempt. After a predetermined number (e.g., three times) of failed connections, the controller may send an error message to the cloud server. The error message may indicate possible connector defects, e.g., broken lock tabs, etc.

In step 625, the controller sends a connection completion message to the server. In step 630, the robotic arm is transported to a next location to perform a subsequent module DC wiring operation. Such steps are iterated until all module DC wirings for the multiple solar modules are completed. Alternatively, the controller may complete the task first and send an overall report to the server. The overall report may comprise successful connections, failed connections if any, locations of each failed connection, etc.

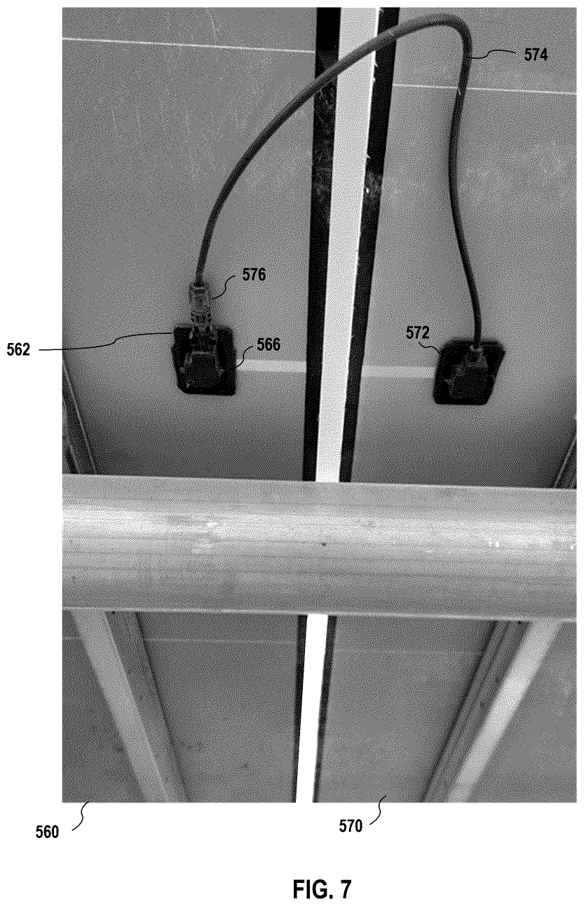

FIG. 7 shows completed module DC wiring between two adjacent modules in accordance with various embodiments of the invention. Once the wiring is completed, the MC4 female connector 576 is connected to the MC4 male connector 566, and the solar module 560 and the solar module 570 are connected successfully in series.

To perform automatic DC wiring for solar modules that have two wires (e.g., the modules 310 and 320 as shown in FIG. 3), two robotic arms or one robotic arm with one additional gripper may be needed. For example, a first robotic arm is used to grip one connector of a first solar module, while a second robotic arm is used to hold a corresponding connector of a second solar module.

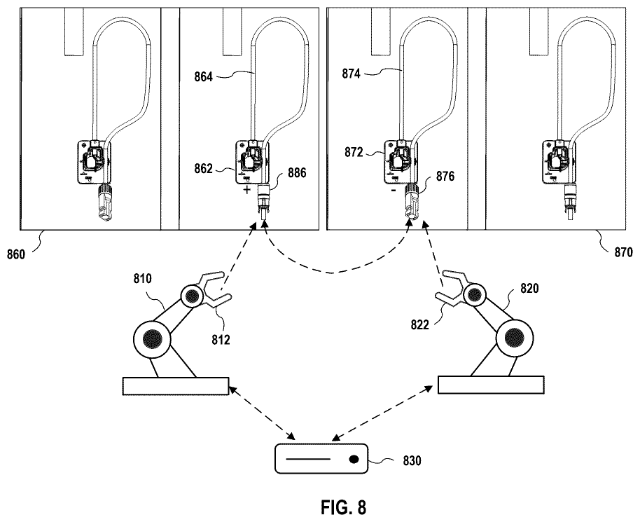

FIG. 8 shows an overview of a system with two robotic arms for automatic module DC wiring in accordance with various embodiments of the invention. The system comprises a first robotic arm 810, a second robotic arm 820, and a controller 830 coupled to both robotic arms. Each robotic arm may have its own camera or sharing one camera. The first robotic arm 810 comprises a first gripper 812 that can perform gripping, releasing, extending, withdrawing, and/or rotation operations to grip a first connector 866 of a first wire 864 that connects to a first junction box 862 on the first solar module 860. Similarly, the second robotic arm 820 comprises a second gripper 822 that may be controlled to grip a second connector 876 of a second wire 874 that connects to a second junction box 872 on the second solar module 870.

The first robotic arm 810 and the second robotic arm 820 are jointly controlled by the controller 830 for collaborated movement to connect the second connector 876 to the first connector 866, thus completing DC wiring between the first solar module 860 and the second solar module 870. The aforementioned steps in FIG. 6, e.g. identifying and locating connectors, operating movements of a robotic arm (including connection verification), may also be applicable to the embodiment of using robotic arms 810 and 820.

Alternatively, instead of using two robotic arms to perform connection between two connectors, a single robotic arm and one additional gripper may be used. The additional gripper may be a fixed gripper that can perform gripping and releasing only. During operation, the single robotic arm may be operated to grip a first connector and pass the gripped first connector to the additional gripper. Afterwards, the single robotic arm may then be operated to grip the second connector and move the gripped second connector toward the additional gripper to implement connection between the two connectors. Finally, the additional gripper is operated to release the first connector, and the single robotic arm releases the second connector to complete the DC wiring operation between the first solar module and the second solar module. Such an implementation is more cost-friendly compared to the approach of using two robotic arms, although the implementation takes extra time to finish one module DC wiring operation due to two separate connector gripping operations in sequence.

### B. Embodiments of Automatic Module DC Wiring at an Assembly Factory

Although the process shown in FIG. 6 is for on-site module DC wiring, one skilled in the art shall understand that one or more steps may also be implemented in a centralized solar table assembly factory. The steps may comprise ambient image capturing and analysis, connector identification and locating, connector connecting and verifying, etc. A robotic arm may be deployed next to a solar table assembly line to implement module DC wiring for solar modules installed on a torque tube. The module wiring may be performed in parallel to or subsequent to module installation. The robotic arm may be deployed at a fixed location or on a rail for movement, along with an assembled solar table. Accordingly, a solar table may be pre-assembled in the centralized factory with multiple solar modules that are not only pre-assembled onto a torque tube but also pre-wired for DC connection. In this way, the pre-assembly and pre-wired solar table can be transported to an on-site spot for table installation and table wiring only.

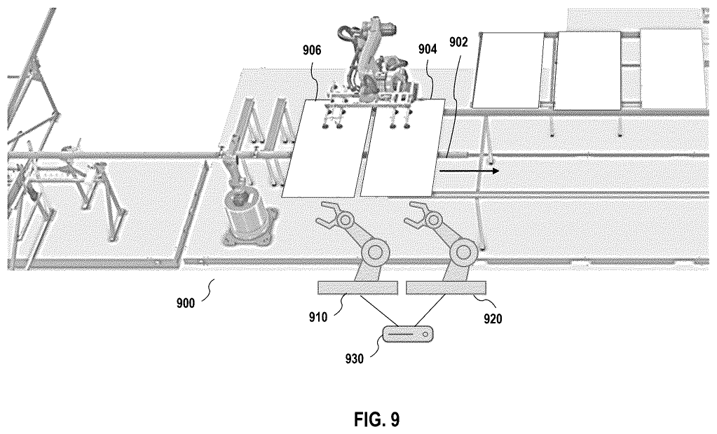

FIG. 9 shows an overview of a system with one or more robotic arms for automatic module DC wiring at a centralized solar table assembly line in accordance with various embodiments of the invention. The solar table assembly line 910 is within a centralized factory which may located at the installation site of a large solar system. As shown in FIG. 9, a solar table 920 is assembled on the assembly line and being moved forward after solar modules 904/906 are attached. One or more robotic arms, e.g., 910 and 920, are placed next to the assembly line. When the assembled or partially assembled solar table 902 is moved near the robotic arm(s), the solar table 902 is stopped and waiting for the robotic arm(s) to perform module DC wiring for solar modules assembled on the solar table. The solar table may be stopped multiple times for the robotic arm(s) to complete module DC wiring for all solar modules on the solar table.

It shall be noted that only one robotic arm may be operated by the controller 930 to perform module DC wiring at an assembly line for solar modules that have one wire, similar to the embodiment shown in FIG. 5. Alternatively, two robotic arms may be operated jointly by the controller 930 to perform module DC wiring at an assembly line for solar modules that have two wires, similar to the embodiment shown in FIG. 8. Since the solar table is moving toward the robotic arm(s), the robotic arm(s) may be anchored to a fixed location without needing transportation to different locations. Therefore, the system for module DC wiring can be simplified.

It shall be noted that extra attention may be needed for a solar table that is pre-assembled and pre-wired in the centralized factory. When such a solar table is transported by a mobile transport vehicle to a final installation location, the solar table may generate a high open-circuit DC voltage since the modules are pre-wired. Therefore, extra attention or insulation may be needed for the connector with the highest electrical potential.

It shall be noted that although MC4 male and female connectors are described in one or more embodiments described above, the present invention may be implemented using other types of male and/or female solar connectors that can electrically couple solar panels. Those solar connectors include but are not limited to Amphenol solar connectors, Tyco Electronics (TE) Solarlok connectors, Radox connectors, etc.

### C. Computing System Embodiments

In one or more embodiments, aspects of the present patent document may include, or may be implemented on one or more computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), Programmable Logic Controller (PLC), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

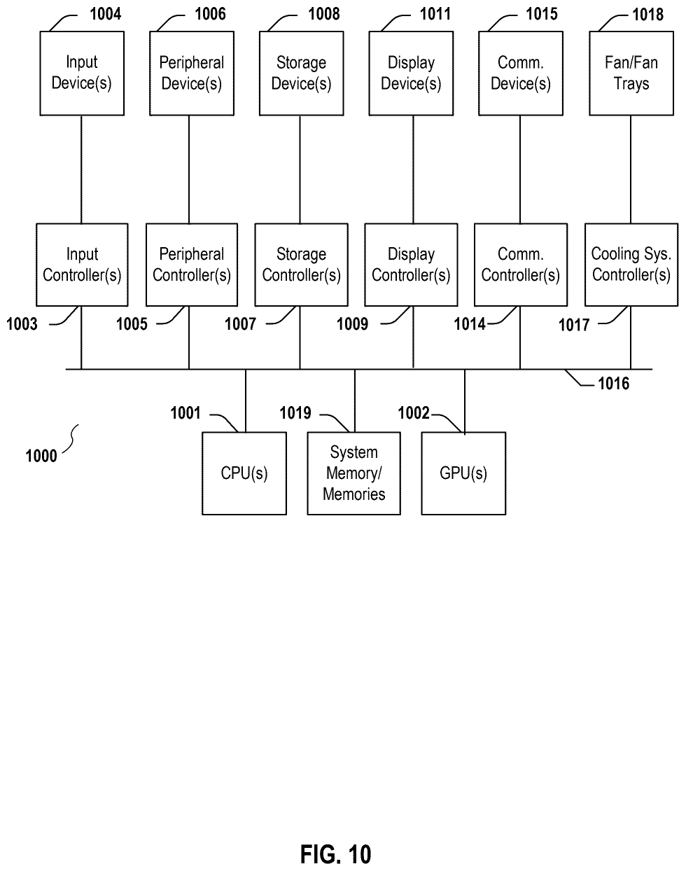

FIG. 10 shows a simplified block diagram of a computing system in accordance with various embodiments of the invention. It will be understood that the functionalities shown for system 1000 may operate to support various embodiments of a computing system—although it shall be understood that a computing system may be differently configured and include different components, including having fewer or more components as depicted in FIG. 10.

As illustrated in FIG. 10, the computing system 1000 includes one or more CPUs 1001 that provide computing resources and control the computer. CPU 1001 may be implemented with a microprocessor or the like, and may also include one or more graphics processing units (GPU) 1002 and/or a floating-point coprocessor for mathematical computations. In one or more embodiments, one or more GPUs 1002 may be incorporated within the display controller 1009, such as part of a graphics card or cards. The system 1000 may also include a system memory 1019, which may comprise RAM, ROM, or both.

A number of controllers and peripheral devices may also be provided, as shown in FIG. 10. An input controller 1003 represents an interface to various input device(s) 1004. The computing system 1000 may also include a storage controller 1007 for interfacing with one or more storage devices 1008 each of which includes a storage medium such as magnetic tape or disk, or an optical medium that might be used to record programs of instructions for operating systems, utilities, and applications, which may include embodiments of programs that implement various aspects of the present disclosure. Storage device(s) 1008 may also be used to store processed data or data to be processed in accordance with the disclosure. The system 1000 may also include a display controller 1009 for providing an interface to a display device 1011, which may be a cathode ray tube (CRT) display, a thin film transistor (TFT) display, organic light-emitting diode, electroluminescent panel, plasma panel, or any other type of display. The computing system 1000 may also include one or more peripheral controllers or interfaces 1005 for one or more peripherals 1006. Examples of peripherals may include one or more printers, scanners, input devices, output devices, sensors, and the like. A communications controller 1014 may interface with one or more communication devices 1015, which enables the system 1000 to connect to remote devices through any of a variety of networks including the Internet, a cloud resource (e.g., an Ethernet cloud, a Fiber Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1000 comprises one or more fans or fan trays 1018 and a cooling subsystem controller or controllers 1017 that monitors thermal temperature(s) of the system 1000 (or components thereof) and operates the fans/fan trays 1018 to help regulate the temperature.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method of solar module DC wiring, the method comprising:
receiving, at a controller, a task of module DC wirings for multiple solar modules in a solar farm under construction, the task comprises module wiring arrangements for the multiple solar modules;
transporting a robotic arm to a first location to start a first module DC wiring operation between a first solar module and a second solar module among the multiple solar modules;
capturing, by a camera or a lidar imaging system, ambient images around the first solar module and the second solar module;
transmitting the captured images to the controller to identify and locate connectors used for a module DC wiring between the first solar module and the second solar module; and
operating, by the controller, movements of the robotic arm to perform the module DC wiring between the first solar module and the second solar module based on the module wiring arrangements of the task and the identified and located connectors.

2. The method of claim 1, wherein the module wiring arrangements comprises one or more of:
a series connection;
a parallel connection; and
a combination of series connection and parallel connection.

3. The method of claim 1, wherein the connectors for DC wiring operation between the first solar module and the second solar module comprise a male connector and a female connector.

4. The method of claim 3, wherein identifying and locating connectors comprise recognition of one or more connector features that comprises one or more of:
connector type;
locking slots on the male connector;
locking tabs on the female connector;
a plug on the male connector; and
a socket on the male connector.

5. The method of claim 3, wherein the movements of the robotic arm comprise:
approaching a gripper of the robotic arm to the female connector;
griping, using the gripper, the female connector;
moving the female connector in proximate to a corresponding male connector, wherein the male connector is attached to a junction box or grabbed by a second gripper;
aligning a pose of the gripped female connector for connection;
engaging a connection between the female connector and the corresponding male connector; and
releasing the gripper.

6. The method of claim 5, wherein engaging the connection between the female connector and the corresponding male connector comprises applying a predetermined insertion force and a predetermined movement distance under the predetermined insertion force.

7. The method of claim 5, wherein the movements of the robotic arm further comprise:
verifying the connection between the female connector and the corresponding male connector, a predetermined force is applied by the robotic arm for a predetermined interval in an attempt for disconnection, if no displacement of the robotic arm is detected, the connection is viewed as a successful connection, and the robotic arm is then operated to release the gripper.

8. The method of claim 7, wherein if a displacement of the robotic arm is detected, the connection is viewed as a failed connection, the robotic arm is operated for a subsequent connection attempt.

9. The method of claim 1, wherein the camera is a stereo camera comprising two or more lenses with a separate image sensor for each lens the two or more lenses are integrated within a gripper for an unobstructed view.

10. The method of claim 1 further comprising:
sending, from the controller to a server, a connection completion message regarding the module DC wiring between the first solar module and the second solar module; and
transporting the robotic arm to a next location to perform a subsequent module DC wiring operation.

11. A system of solar module DC wiring, the system comprising:
a controller that receives a task of module DC wirings for multiple solar modules in a solar farm under construction, the task comprises module wiring arrangements for the multiple solar modules;
a robotic arm coupled to the controller, the robotic arm is transported to a first location to start a first module DC wiring operation between a first solar module and a second solar module among the multiple solar modules;
a camera coupled to the controller, the camera captures ambient images around the first solar module and the second solar module and transmits the captured images to the controller to identify and locate connectors used for a module DC wiring between the first solar module and the second solar module; and
wherein the controller operates movements of the robotic arm to perform the module DC wiring between the first solar module and the second solar module based on the module wiring arrangements of the task and the identified and located connectors.

12. The system of claim 11, wherein the module wiring arrangements comprises one or more of:
a series connection;
a parallel connection; and
a combination of series connection and parallel connection.

13. The system of claim 11, wherein the connectors for DC wiring operation between the first solar module and the second solar module comprise a maleconnector and a female connector.

14. The system of claim 13, wherein the controller identifies and locates connectors using recognition of one or more connector features that comprises one or more of:
connector type;
locking slots on the male connector;
locking tabs on the female connector;
a plug on the male connector; and
a socket on the male connector.

15. The system of claim 13, wherein the movements of the robotic arm comprise:
approaching a gripper of the robotic arm to the female connector;
griping, using the gripper, the female connector;
moving the female connector in proximate to a corresponding male connector, wherein the male connector is attached to a junction box or grabbed by a second gripper;
aligning a pose of the gripped female connector for connection;
engaging a connection between the female connector and the corresponding male connector; and
releasing the gripper.

16. The system of claim 15, wherein engaging the connection between the female connector and the corresponding male connector comprises applying a predetermined insertion force and a predetermined movement distance under the predetermined insertion force.

17. The system of claim 15, wherein the movements of the robotic arm further comprise:
verifying the connection between the female connector and the corresponding male connector, a predetermined force is applied by the robotic arm for a predetermined interval in an attempt for disconnection, if no displacement of the robotic arm is detected, the connection is viewed as a successful connection, and the robotic arm is then operated to release the gripper.

18. The system of claim 17, wherein if a displacement of the robotic arm is detected, the connection is viewed as a failed connection, the robotic arm is operated for a subsequent connection attempt.

19. The system of claim 11, wherein the camera is a stereo camera comprising two or more lenses with a separate image sensor for each lens the two or more lenses are integrated within a gripper for an unobstructed view.

20. The system of claim 11, wherein the controller is further operated to send a connection completion message regarding the module DC wiring between the first solar module and the second solar module to a server.
